(19) United States
(12) Patent Application Publication
(10) Pub. No.: US 2018/0009591 A1
(43) Pub. Date: Jan. 11, 2018

(54) BOTTLE END, MIXING CONTAINER HAVING THE BOTTLE END, AND METHOD FOR MANUFACTURING THE MIXING BOTTLE

(71) Applicants: Yoon Woo KIM, Gyeonggi-do (KR); Koo Wan JEONG, Seoul (KR)

(72) Inventors: Yoon Woo KIM, Gyeonggi-do (KR); Koo Wan JEONG, Seoul (KR)

(21) Appl. No.: 15/634,812

(22) Filed: Jun. 27, 2017

Related U.S. Application Data
(63) Continuation of application No. 15/110,363, filed on Jul. 7, 2016, now abandoned.

(51) Int. Cl. B65D 81/32; B29C 49/64; B65D 8/00; B29C 49/00; B65D 21/02; B29C 49/42; B65D 41/04; B29K 105/00; B29K 67/00; B29L 31/00

(52) U.S. Cl. CPC B65D 81/3211; B29C 49/4273; B29C 49/64; B65D 15/18; B65D 41/04; B29C 49/0005; B65D 21/0231; B29K 2067/003; B29L 2031/7158; B29K 2105/258

(57) ABSTRACT

A mixing container and a method for the manufacturing thereof provide a mixing container which offers high pressure-resistance performance while allowing the sealing membrane to be easily broken when the containers are coupled together, by having the sealing membrane formed in an integrated manner with the metallic bottle end and arranging a breaking line on the sealing membrane. Also, the method for manufacturing a mixing container with which the time and effort required for manufacturing the mixing container may be reduced, to allow mass production at a low cost, as the holding body made from a synthetic resin material and the bottle end made from a metallic material are manufactured separately and subsequently seamed together.

### CROSS REFERENCE

This is a continuation of application Ser. No. 15/110,363, which is pending.

### BACKGROUND

The present invention relates to a bottle end, a mixing container, and a method for the manufacturing thereof. More particularly, the present invention relates to a bottle end, a mixing container, and a method for manufacturing the mixing container, with which multiple pairs of openings having shapes that allow fastening are sequentially connected such that the contents can be mixed together.

Among the variety of products that are widely used in current times, there are certain products that provide a desired effect or an increased effect when two or more components are mixed together, and there are also certain products that are distributed in the form of two or more components held in separate containers with the two or more components intended to be mixed together before use.

Examples of these products include cosmetics, chemicals, pharmaceuticals, foods, etc., such as dyes for dyeing hair, medication and water for injections, liquid resins that begin to harden when mixed with a hardening agent, alcoholic beverages that are mixed with drinking vinegar or plum concentrate, health drinks that include mixed vitamins.

As the above products may deteriorate immediately or may not be suitable for prolonged storage when the components are mixed together, the components are generally stored and distributed in a separated state, to be mixed immediately before use.

Since the components of such a product that are stored and distributed in a separated state are held in separate containers during distribution, there is the drawback that the use of the product has to entail moving the content of a container holding one substance to a container holding another substance or using a separate mixing container.

To remedy this drawback, there have been various research and development efforts conducted on coupling the containers holding different substances so that the contents may be mixed together.

One example can be found in Korean Patent Publication No. 10-2012-0085539 (hereinafter referred to as ‘Patent Document 1’) pertaining to an invention proposed by the applicant.

Patent Document 1 discloses a container in which a pair of openings formed to allow fastening with each other are connected to each other so that the contents may be mixed together.

However, Patent Document 1 does not disclose the specific processing method with which the disclosed structure can be obtained; manufacturing the disclosed structure with a cutting process, etc., would require a very large amount of time and effort, but due to its structure, the blow molding method widely used for reducing production would be very difficult to employ.

Also, the container disclosed in Patent Document 1 uses rubber for the material of the membrane for sealing that prevents the contents from leaking to the outside, but this entails a high risk of the membrane breaking during distribution, resulting in the contents spilling outside, when contents such as carbonated beverages or beer are held that cause a high internal pressure.

Thus, in order to resolve the drawbacks above, there is a need for a container that can reduce the time and cost expended in production, provide high pressure-resistance performance, and enable easy fastening for the mixing of the contents.

### SUMMARY OF THE INVENTION

An embodiment of the present invention aims to provide a mixing container that provides high pressure-resistance performance while allowing easy coupling for the mixing of contents.

Also, an embodiment of the present invention aims to provide a method of manufacturing a mixing container that can reduce the time and effort expended in the production of such mixing container.

According to one aspect of the present invention, a mixing container can be provided which includes: a holding body that has a holding space formed therein and an outlet formed in its upper part, with a fastening portion formed around the outlet and with its lower part open, and a bottle end that couples with the holding body to cover the open lower part of the holding body and has a connecting portion in its middle portion, with the connecting portion shaped in a manner corresponding to the shape of the fastening portion and formed protruding towards the inside of the holding space such that the fastening portion may be inserted inside from the bottom upwards to be fastened thereto, where an inlet hole is formed in the connecting portion into which the fastening portion may enter and a sealing membrane is formed on the upper end of the connecting portion to close the inlet hole, so that when the fastening portion is inserted into the connecting portion, the sealing membrane may be pushed by the front end of the fastening portion and may be broken, resulting in the inlet hole being opened.

The length of the fastening portion can be greater than the length of the connecting portion, so that when the fastening portion is fastened to the connecting portion, the front end of the fastening portion may pass through the inlet hole and may protrude beyond the upper end of the connecting portion.

A first shoulder, shaped such that the diameter of the holding body increases, can be formed between the fastening portion of the holding body and the perimeter of its lower part, and a second shoulder can be formed between the connecting portion of the bottle end and its edge portion, where the outer surface of the first shoulder and the inner surface of the second shoulder can each be shaped to be placed in tight contact with each other when the fastening portion is fastened to the connecting portion.

At a portion of the sealing membrane that is pushed by the front end, a breaking line can be formed in a shape corresponding to the shape of the front end. Here, one or more auxiliary breaking lines can be formed in the sealing membrane in a direction starting from the breaking line and moving towards the edge of the sealing membrane.

A male thread can be formed on the outer perimeter of the fastening portion, while a female thread shaped in correspondence to the male thread can be formed in the inner perimeter of the connecting portion.

The coupling of the holding body and the bottle end can be a seaming coupling between a seaming rib formed in the lower end of the holding body and a seaming rib formed in the edge portion of the bottle end.

The holding body can be of a synthetic resin material, while the bottle end can be of a metallic material. Here, the material for the holding body can be PET, and the material for the bottle end can be aluminum.

According to another aspect of the present invention, a method for manufacturing the mixing container described above can be provided, which includes: forming a main body by way of a heating step of heating the preform body, excluding the head, of a preform that has an opening formed in one side and a head corresponding to the fastening portion formed around the opening, a blowing step of inserting the heated preform body into a cast, of which the upper part of the inner perimeter has a shape corresponding to the portion of the holding body excluding the outlet and of which the middle portion has a sloped groove formed therein that is shaped such that the diameter gradually increases towards the bottom and then gradually decreases again, and afterwards performing blow molding to form an intermediate mold that has the shape of the holding body at its upper part and has a sloped protrusion corresponding to the sloped groove formed in the middle portion of its outer perimeter, and a cutting step of cutting the intermediate mold in a horizontal direction, at the upper sloped surface of the sloped protrusion where the diameter gradually increases towards the bottom, to form the holding body with a seaming rib formed at its lower end; forming the bottle end by applying press processing on a material shaped as a circular plate such that its upper surface is given a shape corresponding to the inner side of the upper part of the holding body and a seaming rib is formed at the edge portion, forming the connecting portion in the middle that is shaped as a cylinder protruding upwards with its upper side closed by the sealing membrane, forming a breaking line in the sealing membrane in the shape of a groove having a smaller thickness than its surroundings, and pressing the outer perimeter of the connecting portion such that its inner perimeter is given a shape corresponding to the outer perimeter of the fastening portion, to form the bottle end; and coupling the holding body with the bottle end by folding the seaming rib of the holding body together with the seaming rib of the bottle end to form a coupling portion.

An embodiment of the present invention can provide a mixing container which offers high pressure-resistance performance while allowing the sealing membrane to be easily broken when the containers are coupled together, by having the sealing membrane formed in an integrated manner with the metallic bottle end and arranging a breaking line on the sealing membrane.

Also, an embodiment of the present invention provides a method for manufacturing a mixing container with which the time and effort required for manufacturing the mixing container may be reduced, to allow mass production at a low cost, as the holding body made from a synthetic resin material and the bottle end made from a metallic material are manufactured separately and subsequently seamed together.

### BRIEF DESCRIPTION OF DRAWINGS

FIG. 1 is a perspective view of a mixing container according to an embodiment of the present invention.

FIG. 2 is a vertical cross-sectional view of the mixing container illustrated in FIG. 1.

FIG. 3 is a magnified view of the portion marked as A in FIG. 2.

FIG. 4 shows an example of coupling a pair of the mixing container illustrated in FIG. 1.

FIG. 5 and FIG. 6 are magnified cross-sectional views for describing the operations of the fastening portion and the connecting portion when a pair of mixing containers are coupled.

FIG. 7 and FIG. 8 are plan views of sealing membranes for describing the breaking line.

FIG. 9 is a flowchart for describing a method of manufacturing a mixing container according to an embodiment of the present invention.

FIG. 10 is a perspective view of a preform used in a method of manufacturing a mixing container according to an embodiment of the present invention.

FIG. 11 through FIG. 14 provide a stepwise illustration of a method of manufacturing a mixing container according to an embodiment of the present invention.

FIG. 15 shows an example of utilizing a byproduct created during the manufacturing process of a method for manufacturing a mixing container according to an embodiment of the present invention.

### DETAILED DESCRIPTION OF THE INVENTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain specific explanations of known art are omitted when it is deemed that they may unnecessarily obscure the essence of the present invention.

Certain embodiments of the present invention will be described below in detail with reference to the accompanying drawings.

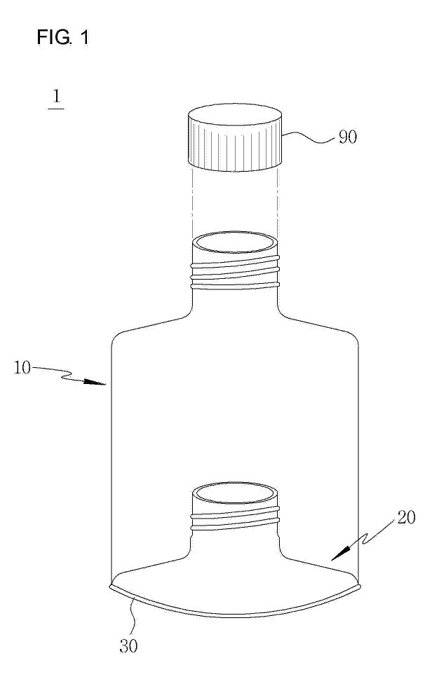

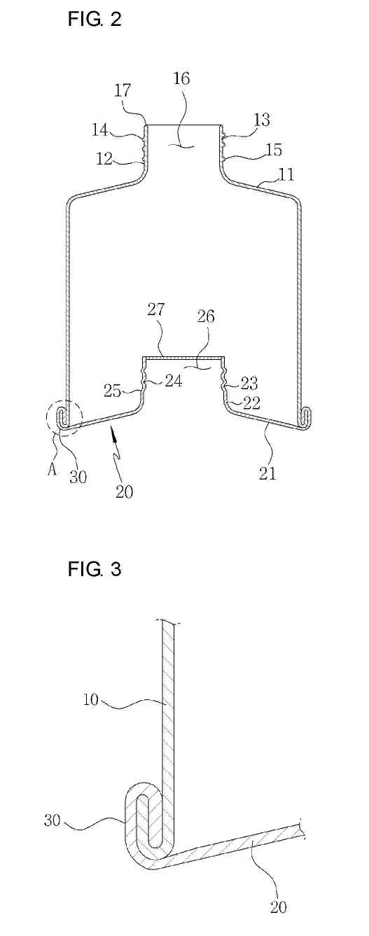

Referring to FIG. 1 and FIG. 2, a mixing container 1 according to an embodiment of the present invention can include a holding body 10, a bottle end 20, and a cap 90.

The holding body 10 may have a holding space formed therein and may be shaped as a container that is open at its lower part. A first shoulder 11, a neck 12, a fastening portion 13, a male thread 14, an outlet 16, and a front end 17, etc., maybe formed on the holding body 10.

The outlet 16 can be formed on an upper part of the holding body 10, as illustrated. Here, the outlet 16 can be the hollow portion of the cylindrically shaped fastening portion 13. The male thread 14 and the curb protrusion 15 can be formed to protrude from the outer perimeter of the fastening portion 13.

The cap 90 may be formed to cover and seal the outlet 16 and may be formed to allow fastening onto the fastening portion 13. That is, a female thread (not shown) corresponding to the male thread 14 can be formed on the inner perimeter of the cap 90.

Here, the cap 90 may be fastened to the fastening portion 13 after a content, which is not illustrated, is held in the holding space inside the mixing container 1, so that the content is not leaked through the outlet 16 to the outside of the mixing container 1.

The upper end of the fastening portion 13 may be chamfered or rounded so as not to form a sharp angle, and the front end 17 refers to the portion of such fastening portion 13 that protrudes outwardly the most.

The holding body 10 can have the neck 12 and the first shoulder 11 formed continuously, as illustrated, according to the size of the holding space formed therein. The first shoulder 11 is the portion formed between the fastening portion 13 and the outer perimeter below it and can be formed in a shape that has the diameter of the holding body 10 increasing. Also, a portion shaped as the perimeter of the hollow cylinder can be formed from the first shoulder 11 to the lower part of the holding body 10.

The curb protrusion 15 may serve to facilitate the handling of the holding body 10, such as during transportation, in the method of manufacturing a mixing container according to an embodiment of the present invention described later on, or may serve to provide contact with the lower end of the cap 90 and be deformed to a desired shape when the cap 90 is coupled on.

Also, in the case of an arrangement in which the cap 90 is first fastened to the fastening portion 13 and the lower end of the cap 90 is torn from the remaining portions when the cap 90 is separated from the fastening portion 13 so that one is able to recognize that the opening is being performed for the first time, the curb protrusion 15 can also serve to prevent the torn portion (not shown) from moving along the neck 12.

However, in some cases, the curb protrusion 15 can be omitted.

A synthetic resin can be used for the material of the holding body 10 described above. If a comestible such as a beverage is to be held in the mixing container 1, a material such as PET (polyethylene terephthalate) that can be used for a comestibles container can be selected.

A second shoulder 21, a neck 22, a connecting portion 23, a female thread 24, a curb ledge 25, an inlet 26, a sealing membrane 27, etc., can be formed on the bottle end 20.

The bottle end 20 can be shaped to cover and seal the open lower part of the holding body 10 and can be coupled with the holding body 10. That is, the lower part of the holding body 10 and the outer perimeter of the bottle end 20, i.e. the portions following the edge, can be coupled continuously to form a coupling portion 30.

The coupling portion 30 can be formed to provide an airtight or a watertight juncture, which will be described below with reference to FIG. 3.

FIG. 3 is a magnified view of the portion marked as A in FIG. 2.

Referring to FIG. 3, the coupling portion 30 may be formed such that the lower portion of the holding body 10 and the edge portion of the bottle end 20 are folded in an overlapping manner as illustrated in the drawing. This is an example of a seaming joint which provides the coupling portion 30 with a superior airtight or watertight juncture.

Although it is not shown in the drawings, the number of folds of the lower portion of the holding body 10 and the edge portion of the bottle end 20 at the coupling portion 30 can be increased according to the property of the product held in the holding body 10.

Referring again to FIG. 1 and FIG. 2, the second shoulder 21 is the portion formed between the connecting portion 23 and the edge portion of the bottle end 20 and can be formed to correspond to the shape of the first shoulder 11. In a middle portion of the bottle end 20, a connecting portion 23 can be formed that protrudes inwardly towards the holding space of the holding body 10.

The connecting portion 23 may be shaped as a hollow cylinder, with an inlet 26 formed on the inside of the connecting portion 23, and a female thread 24 and curb ledge 25 formed on the inner perimeter. The upper surface may be closed by a sealing membrane 27.

Here, the inlet 26 may be formed to accommodate the fastening portion 13 of the holding body 10 when it is inserted upwardly from below. Accordingly, the female thread 24 can be shaped to correspond to the male thread 14, and the curb ledge 25 can be formed in a shape corresponding to the curb protrusion 15. That is, the fastening portion 13 may be formed to allow insertion into and fastening with the connecting portion 23 by way of the male thread 14 and the female thread 24.

A metal can be used for the material of the bottle end 20. A material that is comparatively light, inexpensive, and easy to process can be used, such as aluminum, tin, tinned iron, etc. If a comestible such as a beverage is to be held in the mixing container 1, a metal that is harmless to the human body can be used, or the bottle end 20 can be used with its surface coated with a resin, etc., that is non-toxic and has high acid resistance, durability, weather resistance, corrosion resistance, etc.

Using metal for the material of the bottle end 20 is to utilize metal's property of plastic deformation in keeping a securely coupled state at the coupling portion 30.

The neck 22 may be formed continuously between the second shoulder 21 and the connecting portion 23.

The holding body 10 and the bottle end 20 described above may each be manufactured as a single body, and the coupling portion 30 may be formed to provide an airtight or watertight juncture, so that the holding space within the holding body 10 can be sealed except at the outlet 16.

Thus, as the holding body 10 and the bottle end 20 are coupled while forming the coupling portion 30, the function of a container can be implemented.

While an example is given in which the fastening portion 13 and the connecting portion 23 are fastened by way of a male thread 14 and a female thread 24, it is also possible to form a fastening protrusion or fastening indentation on the outer perimeter of the fastening portion 13 and form a corresponding fastening indentation or fastening protrusion on the inner perimeter of the connecting portion 23, as needed.

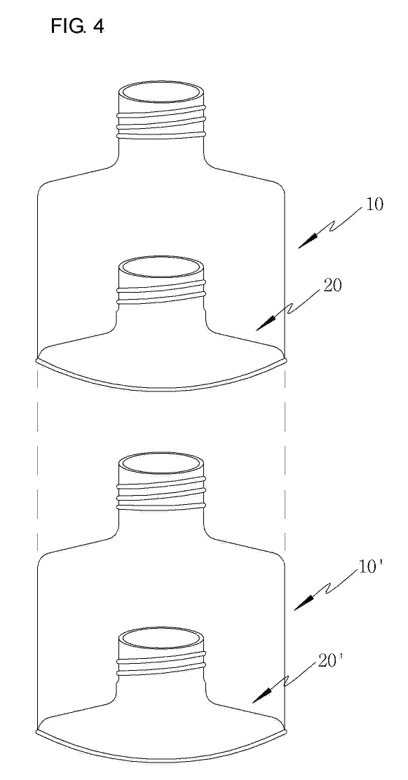

FIG. 4 shows an example of coupling a pair of the mixing container illustrated in FIG. 1. Here, it is assumed that the structures of the holding body 10 and the other holding body 10′ are the same and that the structures of the bottle end 20 and the other bottle end 20′ are the same.

In FIG. 1 and FIG. 4, it is assumed that the holding body 10, 10′ is manufactured from a transparent material, and the bottle end 20, 20′ is represented by solid lines instead of hidden lines.

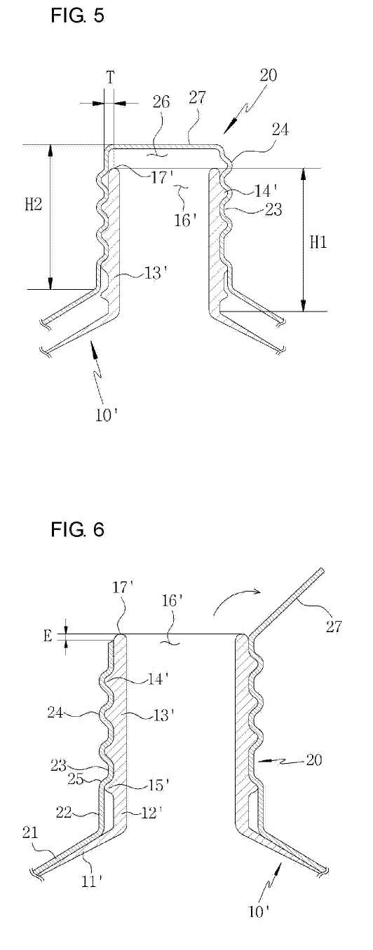

Referring to FIG. 4, onto the container formed by the coupling together of the holding body 10 and the bottle end 20, a container formed by the coupling together of another holding body 10′ and another bottle end 20′ may be coupled. This coupling may be achieved by a fastening between the fastening portion (13 of FIG. 2) and the connecting portion (23 of FIG. 2) as described above. More descriptions are provided below with reference to FIG. 5 and FIG. 6.

FIG. 5 and FIG. 6 are magnified cross-sectional views for describing the operations of the fastening portion and the connecting portion when a pair of mixing containers are coupled. The descriptions that follow refer to FIG. 4 through FIG. 6 taken together.

Referring to FIG. 4 through FIG. 6 taken together, the coupling between the two containers may be achieved when the bottle end 20 is coupled with the holding body 10′ of the other container.

The coupling of the two containers may be achieved as the fastening portion 13′ of the holding body 10′ is fastened to the connecting portion 23 of the bottle end 20, and when the connecting portion 23 and the fastening portion 13′ are fastened completely, the sealing membrane 27 may be broken as illustrated in FIG. 6.

As the sealing membrane 27 breaks, the holding space of the container formed by the holding body 10 and bottle end 20 may connect to the holding space of the other container formed by the holding body 10′ and bottle end 20′. That is, if different kinds of contents are held in the respective holding spaces, the two contents can flow through the outlet 16′ and be mixed together.

Referring first to FIG. 5, the fastening portion 13′ of the holding body 10′ may be inserted into the inlet 26 of the bottle end 20, during which the male thread 14′ may be fastened to the female thread 24. Although it is not illustrated in detail, the fastening portion 13′ may move such that the front end 17′ draws towards the sealing membrane 27, when the holding body 10′ is continuously rotated by the user.

Here, the length (H1) of the fastening portion 13′ maybe formed greater than the length (H2) of the connecting portion 23. This is so that the upper end of the fastening portion 13′, i.e. the front end 17′, protrudes (E) beyond the upper end of the connecting portion 23 when the fastening portion 13′ is completely fastened to the connecting portion 23, as illustrated in FIG. 6, whereby the sealing membrane 27 may be broken by the front end 17′ and be opened.

The length (E) by which the front end 17′ protrudes beyond the connecting portion 23 can be changed according to the properties of the sealing membrane 27 such as its ductility and malleability, etc. If the sealing membrane 27 is manufactured from a material having high ductility and malleability, then the protrusion length (E) can be made greater to sufficiently break the sealing membrane 27.

If the tensile strength of the sealing membrane 27 is too great, the connecting portion 23 can be elongated instead of the sealing membrane 27 being pushed and broken by the front end 17′. Thus, although it is not illustrated in the drawings, the sealing membrane 27 can be formed to have a smaller thickness than that of the connecting portion 23.

When the fastening portion 13′ is completely fastened to the connecting portion 23, the curb protrusion 15′ maybe disposed against the curb ledge 25, which may stop the holding body 10′ from moving further in relation to the bottle end 20 in the direction in which the front end 17′ pushes against the sealing membrane 27. Also, the contact between the curb protrusion 15′ and the curb ledge 25 may increase the sealing effect between the connecting portion 23 and the fastening portion 13′.

In other words, when the sealing membrane 27 begins to break, the substance held in the container formed by the holding body 10 and the bottle end 20 can leak outside through the broken part of the sealing membrane 27.

Here, if the curb protrusion 15′ is made to contact the inner perimeter of the neck 22 before contacting the curb ledge 25, i.e. if the neck portion between the curb ledge 25 and the shoulder 21 is made to have a cylindrical shape with an inner diameter corresponding to the outer diameter of the end portion of the curb protrusion 15′, then it is possible to more efficiently prevent the content from leaking between the outer perimeter of the fastening portion 13′ and the inner perimeter of the connecting portion 23 during the process of coupling the holding body 10′ with the bottle end 20.

When the fastening portion 13′ and the connecting portion 23 are completely fastened, the outer surface of the first shoulder 11′ and the inner surface of the second shoulder 21 can at least partially be placed in tight contact with each other, as illustrated in FIG. 6.

Referring to the container including the holding body 10 and bottle end 20 as a first container, and referring to the container including the holding body 10′ and bottle end 20′ as a second container for convenience, after the fastening portion 13′ and the connecting portion 23 are completely fastened, the first shoulder 11′ and the second shoulder 21 maybe placed in tight contact to support each other as described above when an external force such as a bending stress is applied to the first container and second container, so that a firmer coupling is achieved compared to the case of providing support with only the fastening portion 13′ and the connecting portion 23.

However, the area of contact between the first shoulder 11′ and the second shoulder 21 can be varied according to the weight, material, strength, etc., of the first container and second container, and in some cases, the first shoulder 11′ and the second shoulder 21 may be implemented not to be in tight contact even after the fastening portion 13′ and the connecting portion 23 are completely fastened.

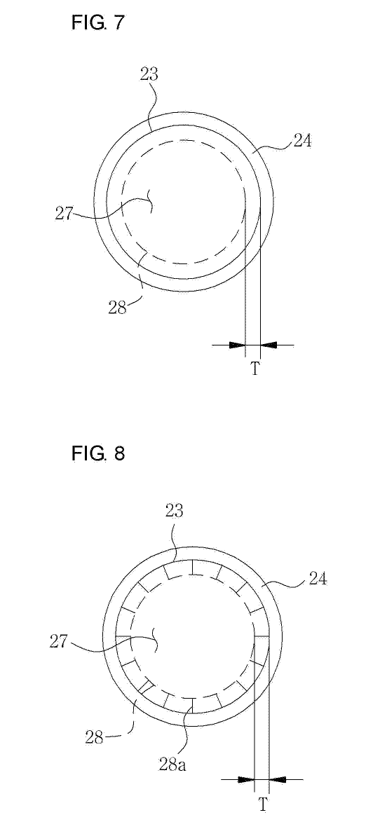

The symbol T indicated in FIG. 5 represents the position where the front end 17′ and the sealing membrane 27 contact each other so that a large amount of force is concentrated, when the sealing membrane 27 is pushed by the front end 17′. This will be described with reference to FIG. 7 and FIG. 8.

FIG. 7 is a plan view of a sealing membrane for describing the breaking line.

Referring to FIG. 7, a breaking line 28 may be formed in the sealing membrane 27, which corresponds to the upper surface of the connecting portion 23, where the breaking line 28 may be formed in a position corresponding to the portion that is pushed by the front end 17′.

Although it is not illustrated in great detail, the breaking line 28 can be formed in one side or the other side or both sides of the sealing membrane 27 and can be formed with a thickness that is thinner than that of the sealing membrane 27. That is, as the portion where the breaking line 28 is formed provides a weaker tensile strength than other portions of the sealing membrane 27, it can break before the other portions when pushed by the front end 17′.

Thus, since the break may progress along the breaking line 28 when the sealing membrane 27 is broken, the shape in which the sealing membrane 27 is broken can be determined beforehand by the breaking line 28.

In particular, the breaking line 28 can be formed in a position where the force is concentrated when pushed by the front end 17′ as described above, i.e. at a position separated by T from the edge of the sealing membrane 27 which is the boundary between the connecting portion 23 and the sealing membrane 27, and the shape of the breaking line 28 can be formed to correspond to the horizontal shape of the front end 17′, i.e. the shape of the portion contacting the sealing membrane 27.

By giving the breaking line 28 such a shape, the force applied by the front end 17′ on the sealing membrane 27 can be utilized as much as possible, so that the force required by the user in rotating the fastening portion 13′ and connecting portion 23 relative to each other until the sealing membrane 27 is broken can be minimized.

The depth of the breaking line 28 can differ according to the properties of the substance held in the mixing container (1 of FIG. 1).

For example, if the substance held is a carbonated drink, the internal pressure of the holding space may be higher, and as such, the depth of the breaking line 28 can be formed smaller, i.e. the thickness of the portion where the breaking line 28 is formed can be made less thinner, so that the sealing membrane 27 is not broken by such pressure.

Conversely, if the substance held is a substance such as mineral water which that does not cause the internal pressure of the holding pressure to be particularly higher than outside the mixing container 1, the breaking line 28 can be given a minimum amount of thickness such that the sealing membrane 27 can be broken easily but within the extent that the sealing membrane 27 is not broken during distribution.

FIG. 8 is a plan view of a sealing membrane for describing another example of the breaking line. FIG. 6 is considered together.

Referring to FIG. 6 and FIG. 8, a multiple number of auxiliary breaking lines 28a may be formed from the breaking line 28 towards the edge of the sealing membrane 27.

Regarding the auxiliary breaking lines 28a, in order for the fastening portion 13′ to be completely fastened to the connecting portion 23 after the sealing membrane 27 is pushed by the front end 17′ and broken along the breaking line 28, the front end 17′ may have to protrude beyond the upper end of the connecting portion 23.

If the sealing membrane 27 is broken only along the breaking line 28, the edge portion of the sealing membrane 27 may remain in the shape of a ring having a width of T. However, the hole formed in the sealing membrane as the breaking line 28 breaks may have a smaller cross-sectional area than the horizontal cross-sectional area of the front end 17′, and this portion would have to be spread out in the direction of movement of the front end 17′ in order for the front end 17′ to protrude upwards.

Therefore, by forming the auxiliary breaking lines 28a as illustrated, the portion remaining after the sealing membrane 27 is broken along the breaking line 28 can also be easily broken when pushed by the front end 17′ to be easily folded in the direction of movement of the front end 17′.

Here, the number of auxiliary breaking lines 28a can be increased or decreased as necessary, and the auxiliary breaking lines 28a can be formed in various shapes, such as diagonal, curved, helical shapes, etc., in addition to the radial shape illustrated in the drawing.

With a mixing container 1 having the structure described above, where the sealing membrane 27 is formed integrated with the metallic bottle end 20 and where a breaking line 28 and auxiliary breaking lines 28a are formed in the sealing membrane 27, the pressure-resistance of the mixing container 1 can be improved, even while allowing the sealing membrane 27 to be easily broken when multiple mixing containers 1 are coupled together.

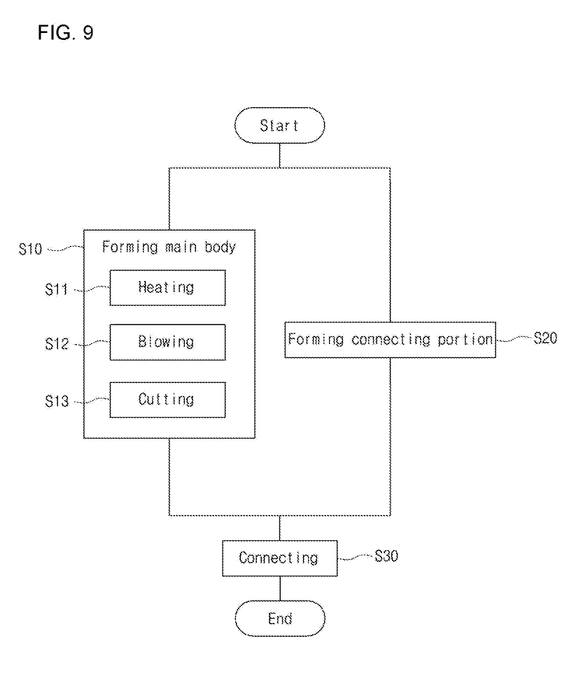

FIG. 9 is a flowchart for describing a method of manufacturing a mixing container according to an embodiment of the present invention.

Referring to FIG. 9, a method of manufacturing a mixing container, for manufacturing the mixing container 1 according to an embodiment of the invention described above, can include a step of forming the main body (S10), a step of forming the bottle end (S20), and a coupling step (S30).

The step for forming the main body (S10) is to form the holding body 10 described above and may include a heating step (S11), a blowing step (S12), and a cutting step (S13).

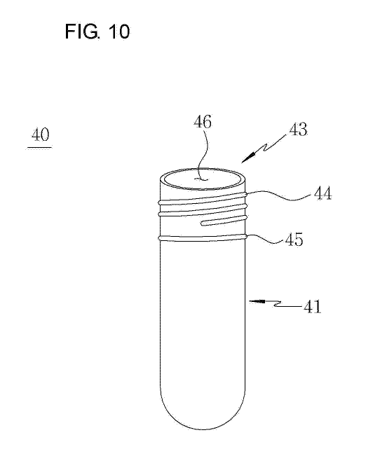

The heating step (S11), which is a step of heating a preform, is described below with reference to FIG. 10.

FIG. 10 is a perspective view of a preform used in a method of manufacturing a mixing container according to an embodiment of the present invention.

Referring to FIG. 10, the preform 40 may include a preform body 41 that is shaped as a hollow cylinder with one side closed, and at the other side of the preform body 41 that is open, a preform head 43 may be formed that includes a male thread 44 and a curb protrusion 45.

The preform 40 refers to an intermediate member made of a thermoplastic resin known as prepreg that is used in manufacturing containers by a method such as blow-molding using hot air, as illustrated in Korean Registered Patent No. 10-0308342 (Title of the Invention: Method and apparatus for heat treating the body of a preform or intermediate container made of thermoplastic material, Registration Date: Aug. 28, 2001).

Here, the preform 40 can be made from PET.

The preform head 43 is the portion corresponding to the fastening portion 13 of the holding body 10 described with reference to FIG. 2, so that the male thread 44 has a shape corresponding to the male thread 14 of the fastening portion 13, the curb protrusion 45 has a shape corresponding to the curb protrusion 15 of the fastening portion 13, and the hole 46 may also have a shape corresponding to the outlet 16.

That is, the preform 40 can be selected or manufactured such that it corresponds to the dimensions of the fastening portion 13 of the holding body 10 being molded.

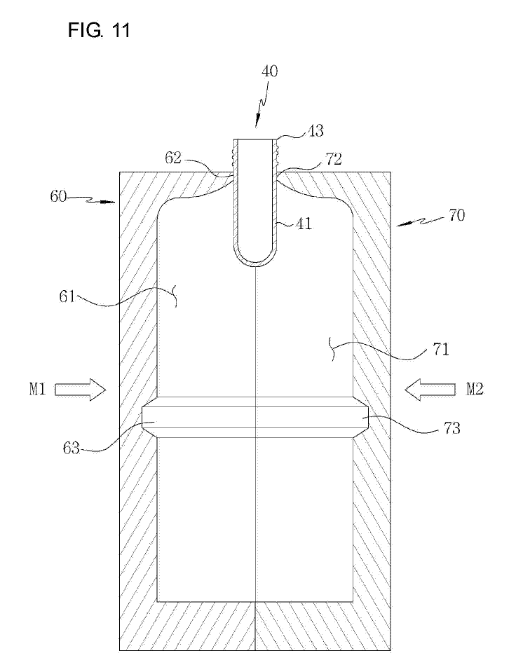

FIG. 11 through FIG. 14 provide a stepwise illustration of a method of manufacturing a mixing container according to an embodiment of the present invention. FIG. 9 is considered together.

In FIG. 11, the preform body 41 is inserted in a preform insertion hole 62, 72 that is formed by casts 60, 70 which have been moved in the directions indicated by M1 and M2 from a separated state to be assembled together.

Although it is not illustrated in the drawings, an operation of heating the portions of the preform body 41 other than the preform head 43 by using a heating means (not shown) such as an oven so that the portions are given a suitable level of malleability, i.e. a heating step (S11), can be preceded before the preform body 41 is inserted into the preform insertion hole 62, 72.

The temperature to which the preform body 41 is heated may differ according to the properties of the thermoplastic resin forming the preform body 41, and the heating can be performed up to a temperature range in which the preform body 41 is given a suitable level of malleability such that the portions of the preform body 41 other than the head 43 can be expanded as desired when hot air is forced through the hole 46.

After the portions of the preform body 41 excluding the preform head 43 are suitably heated due to the heating step (S11), a blowing step (S12) may be performed that includes blow molding.

The blowing step (S12) may include inserting the preform body 41 in the preform insertion hole 62, 72 as illustrated and then fastening a hot air supply means, which is not shown, to the preform head 43.

Inner perimeter surfaces 61, 71 corresponding to the shape to which the preform body 41 is to be deformed during the blowing step (S12) may be formed in the casts 60, 70, with sloped grooves 63, 73 formed in the middle portions.

A sloped groove 63, 73 may be formed with a shape in which the diameter gradually increases towards the bottom and then gradually decreases again.

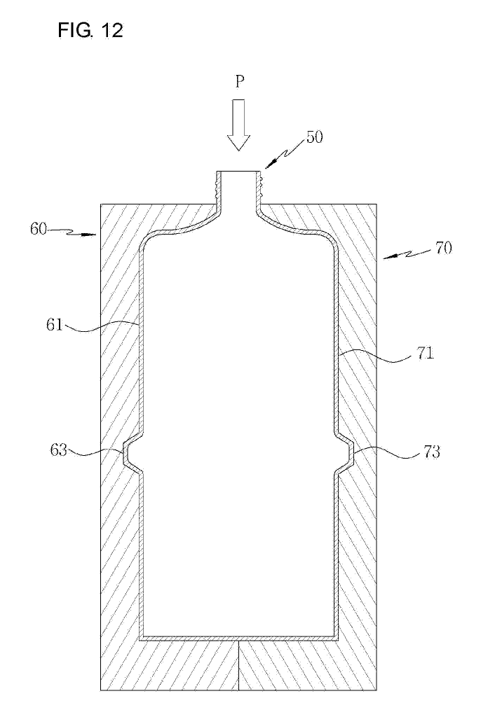

Afterwards, when hot air is forced into the preform body 41 through the hole 46, as indicated by P, using an unshown hot air supply means, the preform body 41 may deform and expand to be in tight contact with the inner perimeter surfaces 61, 71 of the casts 60, 70 including the sloped grooves 63, 73, as illustrated in FIG. 12.

From this state, when the malleability of the deformed preform body is removed or lowered under a certain level, by cooling the casts 60, 70 or allowing a certain amount of time to pass, then an intermediate mold 50 may be completed.

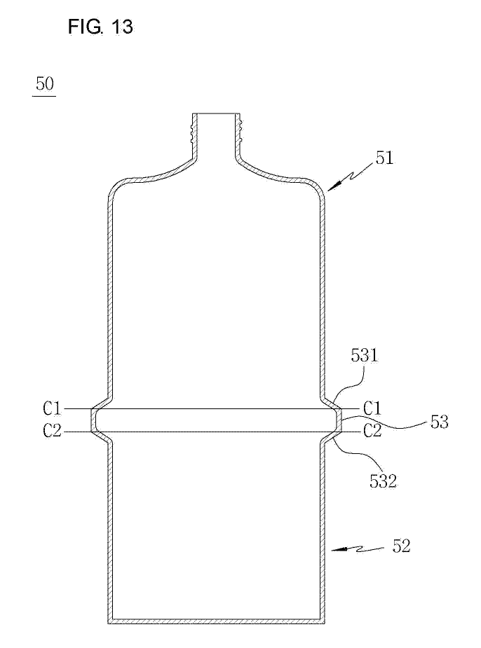

After the intermediate mold 50 is sufficiently cooled, the casts 60, 70 may be separated by moving the casts 60, 70 in opposite directions of the directions marked as M1 and M2 in FIG. 11, to result in the arrangement shown in FIG. 13.

Referring to FIG. 13, the intermediate mold 50 may have the shape of a container in which a sloped protrusion 53 is formed in the middle of its outer perimeter surface, as illustrated in the drawing.

In the intermediate mold 50, if the upper part of the sloped protrusion 53 formed by the sloped grooves 63, 73 is regarded as the upper holding body portion 51 and the lower part is regarded as the lower holding body portion 52, then the upper holding body portion 51 has a shape corresponding to the holding body (10 of FIG. 2) described above.

An upper sloped surface 531 and a lower sloped surface 532 may be formed on the sloped protrusion 53, where the upper sloped surface 531 is shaped such that the diameter of the outer perimeter of the intermediate mold 50 gradually increases towards the bottom, while the lower sloped surface 532 is shaped such that the diameter gradually decreases towards the bottom.

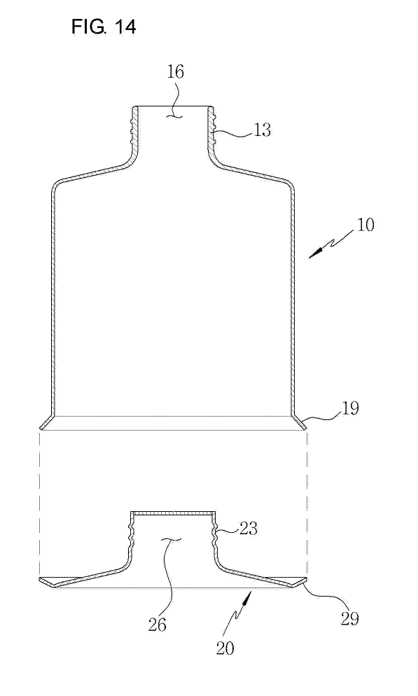

Here, if the upper sloped surface 531 is cut in a horizontal direction across line Cl-Cl, the holding body 10 illustrated in FIG. 14 may be formed. Such operation of cutting the upper sloped surface 531 is referred to herein as the cutting operation (S13).

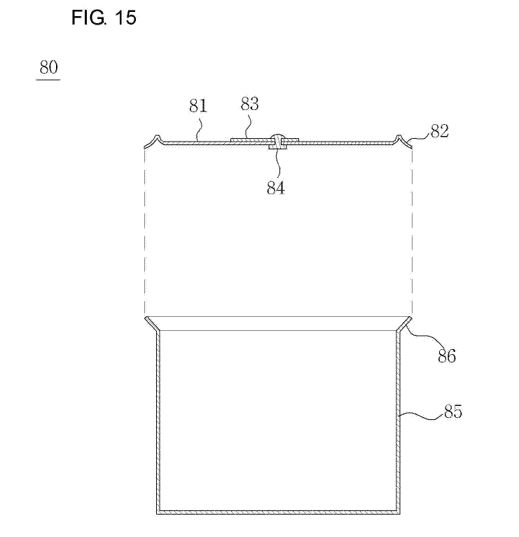

Incidentally, if the lower sloped surface 532 is cut horizontally across line C2-C2, the lower holding body portion 52 may have the shape of a container that is open at the top, and this will be described later with reference to FIG. 15.

Referring to FIG. 14, the holding body 10 may be given the fastening portion 13 and the outlet 16 described above with reference to FIG. 2, but with a seaming rib 19 formed at the lower part.

Thus, the step of forming the main body (S10) can be performed, where the holding body 10 may be formed via the heating step (S11), blowing step (S12), and cutting step (S13).

The step of forming the bottle end (S20) is a step for forming the bottle end 20 having a seaming rib 29 formed thereon, as illustrated in FIG. 14.

Although it is not illustrated in the drawings, the step of forming the bottle end (S20) can be performed by way of press processing, etc.

For example, press processing can be applied to a material shaped as a circular plate such that the upper surface is given a shape corresponding to the inner surface of the upper part of the holding body 10, the seaming rib 29 is formed at the edge portion, a connecting portion 23 is formed in the middle which protrudes upwards and is shaped as a cylinder having its upper surface closed by the sealing membrane 27, and a breaking line 28 is formed in the sealing membrane 27 in the shape of a groove having a smaller thickness than its surroundings.

Afterwards, by using an apparatus such as a lathe, etc., to rotate the press-processed material using a lengthwise axis of the connecting portion 23 as the axis of rotation, pushing the outer perimeter with a bit having a round end, etc., such that a portion is depressed inward, moving the bit at a particular speed in a direction parallel to the axis of rotation according to the speed of the rotation, the female thread 24 can be formed in the inner perimeter of the connecting portion 23 so that the inner perimeter of the connecting portion 23 is given a shape corresponding to the outer perimeter of the fastening portion 13.

In this way, the step of forming the bottle end (S20) can be performed.

The coupling step (S30) is a step for coupling the seaming rib 19 of the holding body 10 with the seaming rib 29 of the bottle end 20 described above by seaming coupling, and is a step in which the seaming rib 19 and the seaming rib 29 are folded together to form the coupling portion 30 as described with reference to FIG. 3.

That is, the coupling step (S30) can be performed such that the holding body 10 and the bottle end 20 are coupled in an airtight or a watertight manner to form the mixing container 1.

FIG. 15 shows an example of utilizing a byproduct created during the manufacturing process of a method for manufacturing a mixing container according to an embodiment of the present invention.

Referring to FIG. 15, a can 80 may include a can end 81 and a can body 85.

Here, the can body 85 is the portion corresponding to the lower holding body portion 52 described above, and a seaming rib 86 formed by the cutting of the lower sloped portion 532 across line C2-C2 is formed at the upper end of the can body 85.

The can end 81 refers to the lid portion of a well-known aluminum or steel can, where an open lever 83 is coupled to the can end 81 by a rivet 84 and a seaming rib 82 is formed at the edge.

After placing a desired product in the holding space of the can body 85, a seaming coupling can be applied to the seaming rib 82 of the can end 81 and the seaming rib 86 of the can body 85, to complete the can 80.

This is to utilize the by-product, i.e. the lower holding body portion 52, produced while proceeding with a method of manufacturing a mixing container according to an embodiment of the present invention.

That is, since the can end 81 is produced according to international standards, a can end 81 corresponding to the dimensions of the lower holding body portion 52 can be selected for forming a can 80, thereby preventing wasted resources.

In particular, an aesthetically pleasing can 80 could be manufactured if the lower holding body portion 52 is made from a transparent material.

A description is provided above of a mixing container and a method for manufacturing the mixing container according to certain embodiments of the present invention, but the spirit of the invention is not limited to the embodiments presented herein. A skilled person who understands the spirit of the invention would easily propose other embodiments by adding, altering, omitting, appending elements or the like without departing from the spirit of the invention, but such embodiments would also fall within the technical scope of the present invention.

1. A bottle end having a seaming rib formed on an edge thereof and having a connecting portion formed protruding from a middle portion thereof,
wherein an inlet hole is formed in the connecting portion, and
a sealing membrane closing the inlet hole is formed at an end portion of the connecting portion.

2. A mixing container comprising:
a holding body having a holding space formed therein, an outlet formed in an upper part thereof, and a fastening portion formed around the outlet, the holding body being open at a lower part thereof; and
a bottle end configured to couple with the holding body such that the open lower part of the holding body is covered,
wherein a connecting portion is formed protruding towards the holding space from a middle portion of the bottle end,
an inlet hole is formed in the connecting portion, the inlet hole having an inner perimeter shaped in correspondence to the fastening portion to receive the outlet as it is inserted upwards from a downward position and fastened, and
a sealing membrane configured to close the inlet hole is formed on an upper end of the connecting portion.

3. The mixing container of claim 2, wherein
a first shoulder is formed between the fastening portion and an outer perimeter of a lower part of the holding body, the first shoulder shaped such that a diameter of the holding body increases,
a second shoulder is formed between the connecting portion and an edge of the bottle end, and
the first shoulder and the second shoulder are formed in shapes corresponding to each other.

4. The mixing container of claim 2, wherein a breaking line is formed in the sealing membrane, the breaking line shaped as a groove having a smaller thickness than surrounding portions.

5. The mixing container of claim 4, wherein one or more auxiliary breaking lines are formed in the sealing membrane from the breaking line towards an edge of the sealing membrane.

6. The mixing container of claim 2, wherein a male thread, a fastening protrusion, or a fastening groove is formed in an outer perimeter of the fastening portion, and a female thread, a fastening groove, or a fastening protrusion corresponding to the male thread, the fastening protrusion, or the fastening groove is formed in an inner perimeter of the connecting portion.

7. The mixing container of claim 2, wherein a coupling of the holding body and the bottle end is performed by a seaming coupling between a seaming rib formed on a lower end of the holding body and a seaming rib formed on an edge portion of the bottle end.

8. The mixing container of claim 2, wherein a material of the holding body is a synthetic resin, and a material of the bottle end is a metal.

9. The mixing container of claim 8, wherein the material of the holding body is PET, and the material of the bottle end is aluminum.

10. A method for manufacturing the mixing container of claim 2, the method comprising:
forming a main body, the forming of the main body comprising:
a heating step of heating a preform body of a preform excluding the head, the perform having an opening formed in one side thereof and a head corresponding to a fastening portion formed around the opening,
a blowing step of inserting the heated preform body into a cast and performing blow molding to form an intermediate mold, the cast having an upper part of an inner perimeter thereof shaped in correspondence to the holding body excluding the outlet, the cast having a sloped groove formed in a middle portion thereof, the sloped groove shaped such that a diameter thereof gradually increases towards a bottom and then gradually decreases again, the intermediate mold having a shape of the holding body at an upper part thereof and having a sloped protrusion corresponding to the sloped groove formed in a middle portion of an outer perimeter thereof, and
a cutting step of cutting the intermediate mold in a horizontal direction, at an upper sloped surface of the sloped protrusion where the diameter gradually increases towards the bottom, to form the holding body with a seaming rib formed at a lower end thereof;
forming a bottle end by forming a seaming rib at an edge portion thereof, forming the connecting portion in a middle portion thereof in a shape of a cylinder protruding upwards with an upper side thereof closed by the sealing membrane, forming a breaking line in the sealing membrane in a shape of a groove having a smaller thickness than surrounding portions, and pressing an outer perimeter of the connecting portion such that an inner perimeter thereof is given a shape corresponding to an outer perimeter of the fastening portion, to form the bottle end; and
coupling the holding body with the bottle end by folding the seaming rib of the holding body together with the seaming rib of the bottle end to form a coupling portion.

11. The bottle end of claim 1, wherein a male thread, a fastening protrusion, or a fastening groove is formed in an inner perimeter of the connecting portion.

12. The bottle end of claim 1, wherein a breaking line is formed in the sealing membrane, the breaking line shaped as a groove having a smaller thickness than surrounding portions.

13. The bottle end of claim 1, wherein one or more auxiliary breaking lines are formed in the sealing membrane from the breaking line towards an edge of the sealing membrane.
